(19) United States
(12) Patent Application Publication
(10) Pub. No.: US 2023/0327486 A1
(43) Pub. Date: Oct. 12, 2023

(54) Magnetic mechanism for wireless charger

(71) Applicant: Wei Chen, Shenzhen (CN)

(72) Inventor: Wei Chen, Shenzhen (CN)

(21) Appl. No.: 18/210,089

(22) Filed: Jun. 15, 2023

(51) Int. Cl. H02J 50/00; H02J 7/00; H02J 50/10

(52) U.S. Cl. CPC H02J 50/005; H02J 7/0044; H02J 50/10; G04G 17/02

(57) ABSTRACT

A wireless charging device includes a bottom shell and a mounting cavity in the bottom shell. The mounting cavity protrudes from the bottom shell. A magnetic suction body is movably arranged in the mounting cavity. One side of the magnetic suction body is an S-pole surface, and the other side thereof is an N-pole surface. A recess at a bottom of the mounting cavity is curved or flat. When the magnet on the watch is an S-pole surface and the N-pole surface of the magnetic suction body faces upwards, the fastening mechanism is fastened. When the magnet on the watch is an N-pole surface and the N-pole surface of the magnetic suction body faces upwards, after the magnetic suction body flips 180 degrees, the S-pole surface of the magnetic suction body faces upwards. At this time, the magnetic suction body and the watch are attracted each other.

### BACKGROUND OF THE INVENTION

### 1. Field of the Invention

The invention relates to wireless charging devices and more particularly to a wireless charging device having a magnetic fastening mechanism.

### 2. Description of Related Art

Currently, major manufacturers such as Huawei, Apple, Samsung, and others have introduced smart watches that utilize magnetic positioning for wireless charging. However, each brand uses different polarities for their magnetic alignment and charging.

For instance, Apple watches use an N-pole magnetic attraction, requiring the charging dock to have an S-pole magnetic component. On the other hand, Samsung watches use an S-pole magnetic attraction, necessitating an N-pole magnetic component in the charging dock. This lack of uniformity among magnetic polarities makes it impossible to use a single wireless charging device for charging different products, leading to increased economic burden for consumers and cluttered desktops.

Thus, the need for improvement still exists.

### SUMMARY OF THE INVENTION

In order to overcome the aforementioned drawbacks of the existing technology, embodiments of the invention provide a wireless charging automatic magnetic fastening mechanism to address the issues raised in the background technology.

To achieve the above objectives, the invention provides the following technical solution: a wireless charging automatic magnetic fastening mechanism comprising a wireless charging device body. The wireless charging device body includes a bottom shell, and at least one mounting cavity is provided inside the bottom shell.

The mounting cavity protrudes from the bottom shell, and a magnetic suction body is movably arranged inside the mounting cavity. One side of the magnetic suction body is an S-pole surface, and the other side is an N-pole surface.

The mounting cavity has a curved or flat structure at the bottom of the cavity.

The inner diameter width of the mounting cavity is greater than the diameter width of the magnetic suction body, and the depth of the mounting cavity is greater than the height of the magnetic suction body. When the magnet on the watch is an S-pole surface and the N-pole surface of the magnetic suction body in the cavity is facing upward, the magnetic attraction between the magnets is utilized to fix the charging device. When the magnet on the watch is an N-pole surface and the N-pole surface of the magnetic suction body in the cavity is facing upward, the magnetic suction body flips 180 degrees inside the cavity, and the S-pole surface of the magnetic suction body faces upward. At this time, the magnetic suction body and the watch attract each other and fix the position, achieving compatibility between the wireless charging device body and various brands of watches for charging.

Preferably, a compatible circuit board is also provided inside the bottom shell.

Preferably, a bracket is installed above the circuit board, and the upper surface of the bracket is equipped with a wireless charging coil.

Preferably, the wireless charging device body also includes a cover that is compatible with the bottom shell and is fixed above the bottom shell using screws or fasteners.

Preferably, holes are opened at the middle positions of the circuit board, bracket, and wireless charging coil, and the mounting cavity passes through the reserved holes of the circuit board, bracket, and wireless charging coil to make contact with the inner surface of the cover.

Preferably, the number of mounting cavities can be set as multiple sets, and the number of magnetic suction bodies inside the mounting cavities is matched with the number of mounting cavities.

Preferably, the wireless charging device body can be designed in any shape.

Preferably, the magnetic suction body is made of magnets or materials with magnetic properties.

Preferably, one side of the circuit board is also soldered with a charging plug, which penetrates through the bottom shell and the cover.

Preferably, a cap is also provided on the outer side of the charging plug, which is compatible with the wireless charging device body, and the cap is securely installed on the end of the charging plug on the wireless charging device body.

The invention has the following advantages and benefits in comparison with the conventional art:

The invention improves the conventional wireless charging device by setting up a cavity in the charging structure. The inner diameter width of the cavity is greater than the width of the magnetic suction body, and the depth of the cavity is greater than the length of the magnetic suction body. By utilizing the principle of magnetic repulsion between magnets, the magnetic suction body can flip inside the cavity and securely fix watches with different magnetic polarities. Once the watch is fixed, the electromagnetic coil can wirelessly charge the watch. Compared to existing technology, the invention achieves compatibility between a wireless charging device and various brands of watches, maximizing resource utilization and providing high practicality.

The above and other objects, features and advantages of the invention will become apparent from the following detailed description taken with the accompanying drawings.

### BRIEF DESCRIPTION OF THE DRAWINGS

FIG. 1 is a perspective view of a wireless charging device according to the invention;

FIG. 2 is a perspective view of the wireless charging device with the cover being separated;

FIG. 3 is a perspective view of the wireless charging device with the cap being separated;

FIG. 4 is a top plan view of the wireless charging device;

FIG. 5 is a sectional view taken along line A-A of FIG. 4;

FIG. 6 is a perspective view of the bottom shell;

FIG. 7 is a perspective view of the wireless charging coil disposed on the support body with the holes formed through them; and

FIG. 8 is a perspective view of the circuit board with another hole formed through.

### DETAILED DESCRIPTION OF THE INVENTION

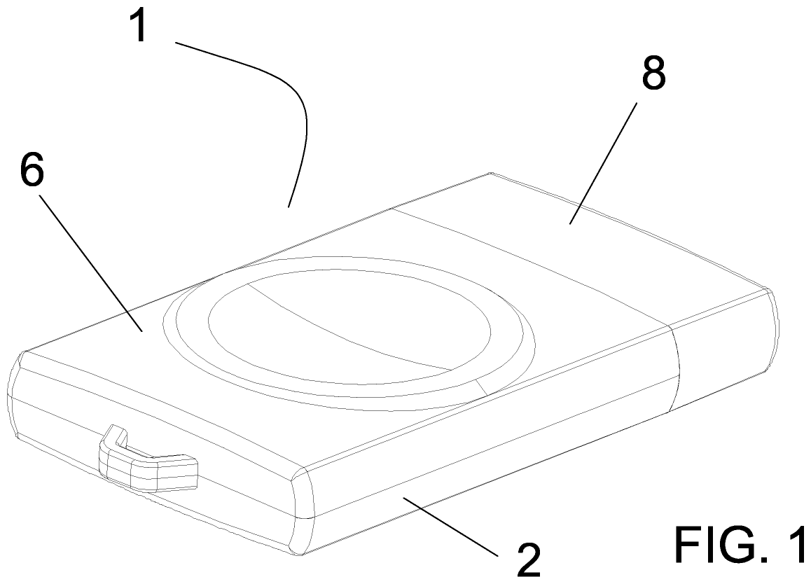

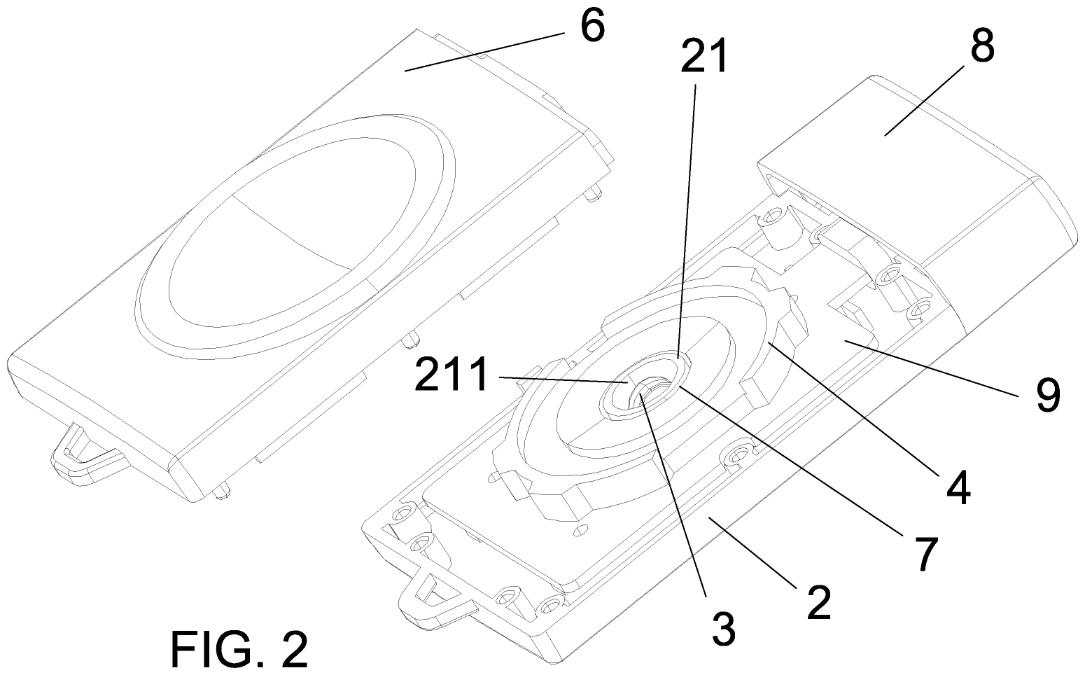

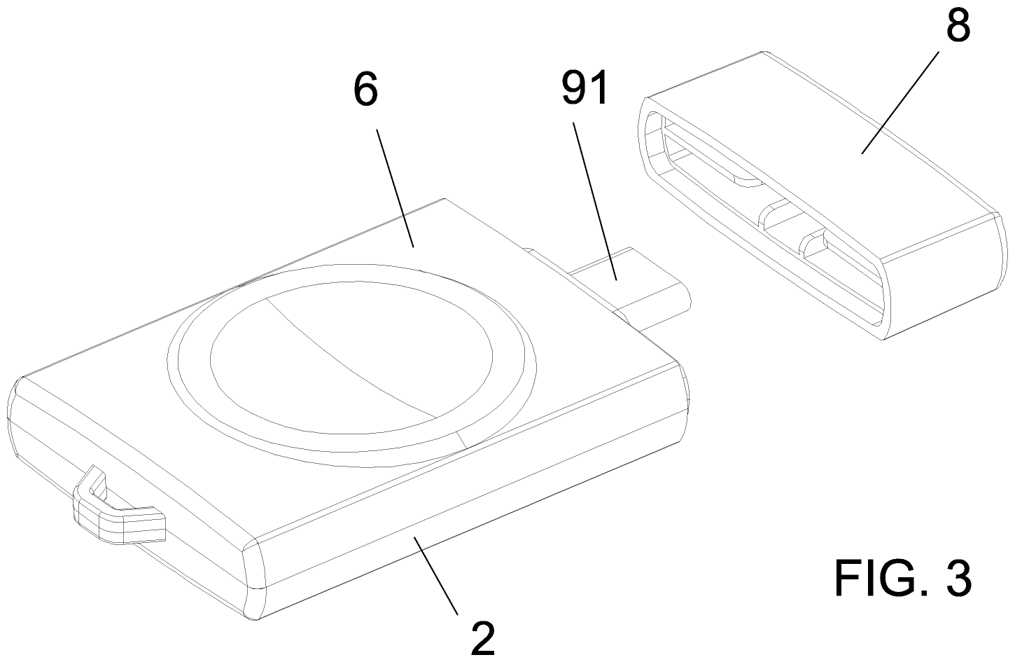

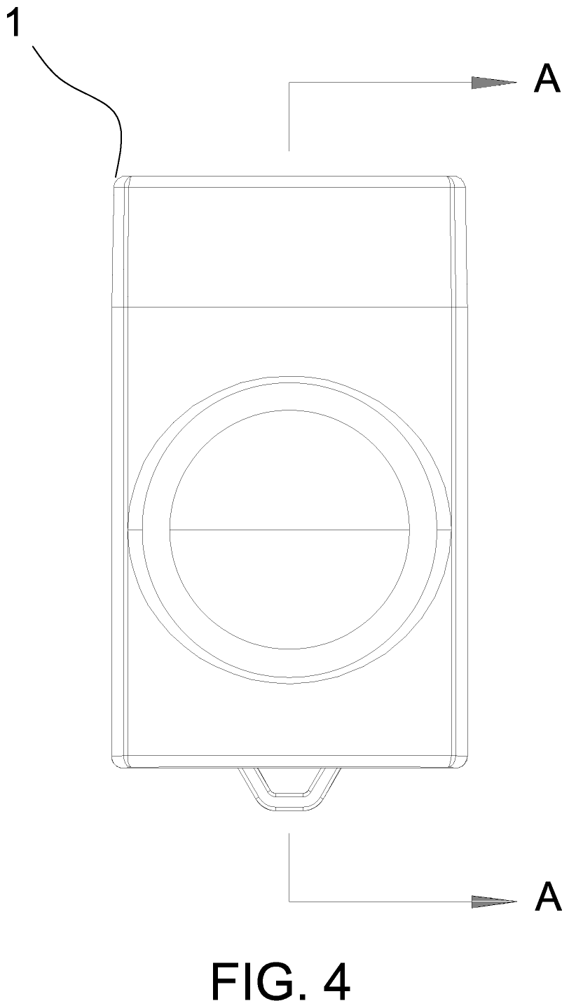

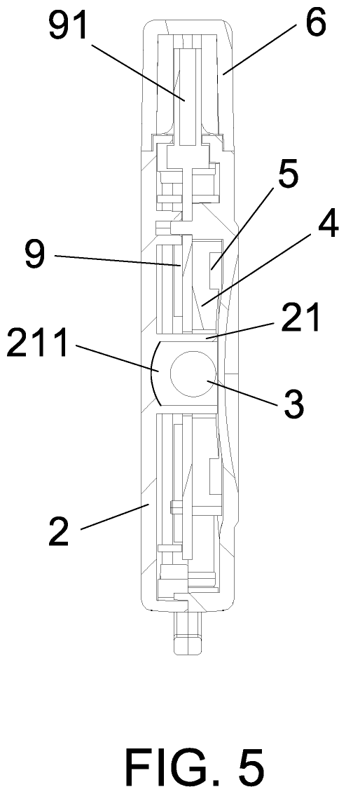

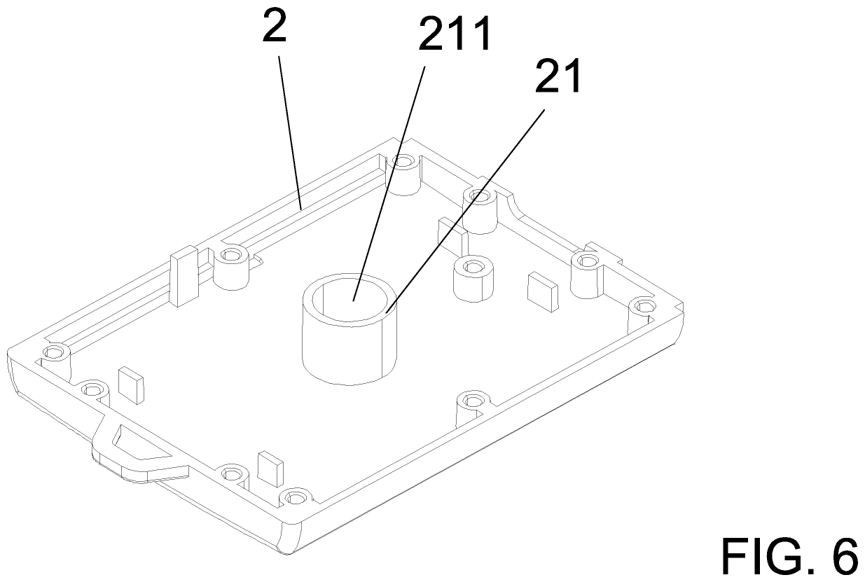

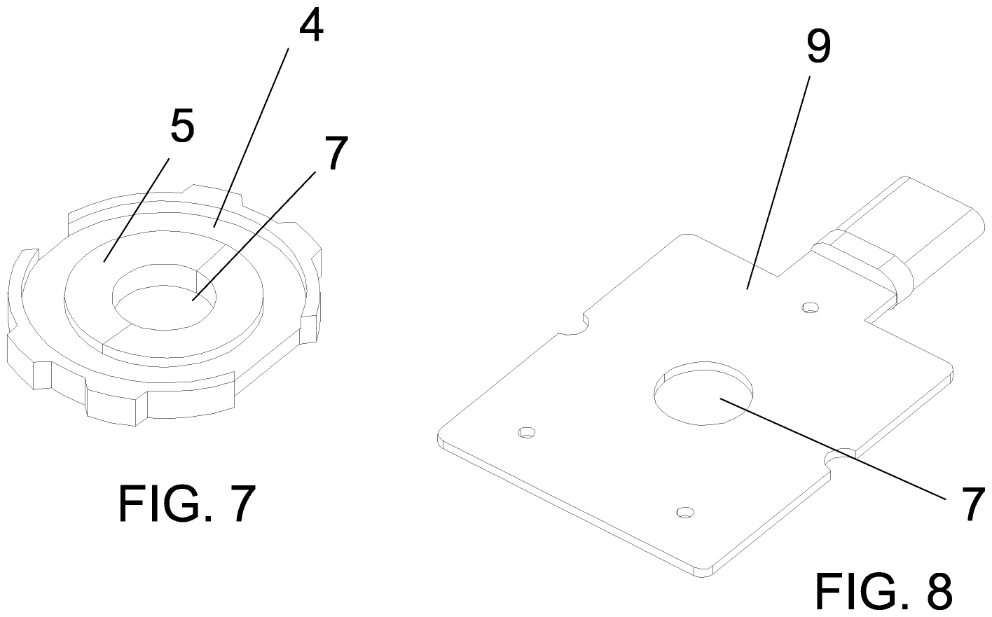

Referring to FIGS. 1 to 8, a wireless charging device 1 in accordance with the invention comprises a bottom shell 2 with at least one internal mounting cavity 21. The mounting cavity 21 protrudes from the bottom shell 2, and a magnetic suction element 3 is movably arranged within the mounting cavity 21. One side of the magnetic suction element 3 is an S-pole surface, and the other side thereof is an N-pole surface. The bottom of a recess 211 of the mounting cavity 21 is curved or flat. The inner diameter of the recess 211 of the mounting cavity 21 is greater than the diameter of the magnetic suction element 3, and the depth of the recess 211 is greater than the height of the magnetic suction element 3. When the magnet on the watch is an S-pole surface and the N-pole surface of the magnetic suction element 3 inside the recess 211 is facing upwards, the charging device is fixed using the principle of magnetic attraction between opposite poles. When the magnet on the watch is an N-pole surface and the N-pole surface of the magnetic suction element 3 inside the recess 211 is facing upwards, the magnetic suction element 3 flips 180 degrees inside the recess 211, and its S-pole surface faces upwards. At this time, the magnetic suction element 3 and the watch attract and fix each other, achieving compatibility of the wireless charging device with multiple different brands of watches.

An appropriately matched circuit board 9 is further provided inside the bottom shell 2. Above the circuit board 9, there is a support body 4 which is installed with a wireless charging coil 5 on its upper surface. The wireless charging device 1 also includes a cover 6 that is compatible with the bottom shell 2. The cover 6 is fixed above the bottom shell 2 using screws or fasteners. The circuit board 9, support body 4, and the middle position of the wireless charging coil 5 are all provided with apertures 7. The mounting cavity 21 passes through the apertures 7 reserved in the circuit board 9, support body 4, and wireless charging coil 5 and comes into contact with the inner side of the cover 6. By fitting the circuit board 9 around the mounting cavity 21, it is advantageous for saving internal space of the wireless charging device 1, reducing the overall volume and dimensions of the product, and making it more convenient to carry.

The number of mounting cavities 21 can be set as multiple groups, and the number of magnetic suction elements 3 inside the mounting cavities 21 is matched with the number of mounting cavities 21. By setting multiple groups of mounting cavities 21 and appropriately matched magnetic suction elements 3, multiple watches can be charged simultaneously. The wireless charging device 1 can be designed in any shape, providing consumers with more options in terms of appearance.

The magnetic suction element 3 is specifically made of magnets or materials with magnetic properties.

One side of the circuit board 9 is also soldered with a charging plug 91, which passes through the bottom shell 2 and the cover 6. The outer side of the charging plug 91 is further equipped with a cap 8, which is compatible with the wireless charging device 1. The cap 8 is installed and secured on the end of the charging plug 91 on the wireless charging device 1. By setting the cap 8, it effectively prevents damage, water ingress, or dust accumulation on the charging plug 91.

Working Principle of the Utility Model:

This device utilizes the characteristics of the magnetic suction element 3, with one side as the S-pole and the other side as the N-pole. It incorporates a mounting cavity 21 with an inner diameter and depth greater than the diameter and length of the magnetic suction element 3. When both the magnetic suction surfaces of the watch and the wireless charging device 1 are S-poles, the magnetic attraction between the magnet in the watch remains unchanged. Placing the watch on the wireless charging device 1 generates a repulsive force based on the principle of like poles repelling each other. Under this repulsive force, the magnetic suction elements 3 inside the wireless charging device 1 are pushed to the bottom of the recess 211. The magnetic suction elements 3 inside the wireless charging device 1 are designed to be movable, and the inner diameter and depth of the recess 211 in the mounting cavity 21 are larger than the diameter and length of the magnetic suction element 3. Additionally, the bottom of the recess 211 in the mounting cavity 21 is designed in an arc shape. As a result, the magnetic suction elements 3 inside the wireless charging device 1 automatically flip 180 degrees to the N-pole surface along the arc-shaped recess 211. The N-pole surface of the magnetic suction elements 3 inside the wireless charging device 1 faces upward and magnetically attaches to the S-pole surface of the magnet inside the watch, thereby achieving a secure fixation. Charging begins. If the magnetic suction surface of the watch is the N-pole, the working principle is the same as described above. In summary, the utility model achieves universal charging for watches, reduces the financial burden on customers, increases market competitiveness, and features a simple and practical design.

While the invention has been described in terms of preferred embodiments, those skilled in the art will recognize that the invention can be practiced with modifications within the spirit and scope of the appended claims.

What is claimed is:

1. A wireless charging device, comprising a bottom shell and a mounting cavity disposed in the bottom shell;
wherein a mounting cavity protrudes from the bottom shell, and a magnetic suction body is movably arranged inside the mounting cavity;
wherein one side of the magnetic suction body is an S-pole surface, and the other side thereof is an N-pole surface;
wherein a recess at a bottom of the mounting cavity has a curved structure or a flat structure;
wherein an inner diameter of the recess is greater than a diameter of the magnetic suction body, and a depth of the recess is greater than a height of the magnetic suction body;
wherein when the magnet on the watch is an S-pole surface and the N-pole surface of the magnetic suction body in the recess faces upwards, the wireless fastening mechanism is fixed using the principle of magnetic attraction between different poles; and
wherein when the magnet on the watch is an N-pole surface and the N-pole surface of the magnetic suction body in the recess faces upwards, after the magnetic suction body flips 180 degrees inside the recess, the S-pole surface of the magnetic suction body faces upwards, at this time, the magnetic suction body and the watch are attracted to each other, achieving compatibility of the wireless charging device with various brands of watches for charging purposes.

2. The wireless charging device of claim 1, further comprising a circuit board arranged inside the bottom shell.

3. The wireless charging device of claim 2, further comprising a support body disposed above the circuit board, and a wireless charging coil disposed on an upper surface of the support body.

4. The wireless charging device of claim 2, further comprising a cover, wherein the cover is compatible with the bottom shell and is fixed above the bottom shell by screws or clasps.

5. The wireless charging device of claim 3, further comprising a plurality of holes disposed through the wireless charging coil, the support body, and the circuit board; wherein the mounting cavity passes through the holes to contact an inner surface of the cover.

6. The wireless charging device of claim 1, wherein the number of mounting cavities can be set as multiple groups, and the number of magnetic suction bodies in each mounting cavity is compatible with the number of mounting cavities.

7. The wireless charging device of claim 1, wherein the wireless charging device can be designed in any shape.

8. The wireless charging device of claim 1, wherein the magnetic suction body is specifically made of a magnet or a material with magnetic properties.

9. The wireless charging device of claim 4, wherein one side of the circuit board is also soldered with a charging plug, and the charging plug passes through the bottom shell and the cover.

10. The wireless charging device of claim 9, wherein the charging plug is further equipped with a cap on its outer surface, and the cap is compatible with the wireless charging device and fastened at an end of the charging plug.
